(19) United States
(12) Patent Application Publication
(10) Pub. No.: US 2016/0002948 A1
(43) Pub. Date: Jan. 7, 2016

(54) Electronic Memorial System

(71) Applicants: Jaime Galarza, Lancaster, PA (US); Jose Munoz, Lancaster, PA (US)

(72) Inventors: Jaime Galarza, Lancaster, PA (US); Jose Munoz, Lancaster, PA (US)

(21) Appl. No.: 14/323,593

(22) Filed: Jul. 3, 2014

(51) Int. Cl. E04H 13/00; H04N 5/64; H04N 5/63; H04R 1/10; H04N 5/44; H04N 5/60; H04N 5/775; H04R 1/02

(52) U.S. Cl. CPC E04H 13/003; H04N 5/775; H04N 5/64; H04R 1/028; H04R 1/1091; H04N 5/4403; H04N 5/602; H04N 5/63; H04N 2005/443; H04R 2499/15; H04R 2420/03

(57) ABSTRACT

An electronic memorial system plays audio and visual information related to a deceased person in order to honor and remember the deceased person. The system includes a grave marker. A display assembly is coupled to the grave marker. The display assembly includes a screen for displaying visual information about a deceased person when the display assembly is activated. A processor is electrically coupled to the display assembly. A speaker is electrically coupled to the processor wherein the speaker emits audio information about the deceased person when the speaker is activated.

### BACKGROUND OF THE DISCLOSURE

### Field of the Disclosure

The disclosure relates to memorial systems and more particularly pertains to a new memorial system for playing audio and visual information related to a deceased person in order to honor and remember the deceased person.

### SUMMARY OF THE DISCLOSURE

An embodiment of the disclosure meets the needs presented above by generally comprising a grave marker. A display assembly is coupled to the grave marker. The display assembly includes a screen for displaying visual information about a deceased person when the display assembly is activated. A processor is electrically coupled to the display assembly. A speaker is electrically coupled to the processor wherein the speaker emits audio information about the deceased person when the speaker is activated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of an electronic memorial system according to an embodiment of the disclosure.

FIG. 2 is a top view of an embodiment of the disclosure.

FIG. 3 is a front view of an embodiment of the disclosure.

FIG. 4 is a schematic diagram view of an embodiment of the disclosure.

FIG. 5 is a front view of a housing of an embodiment of the disclosure.

### DESCRIPTION OF THE PREFERRED EMBODIMENT

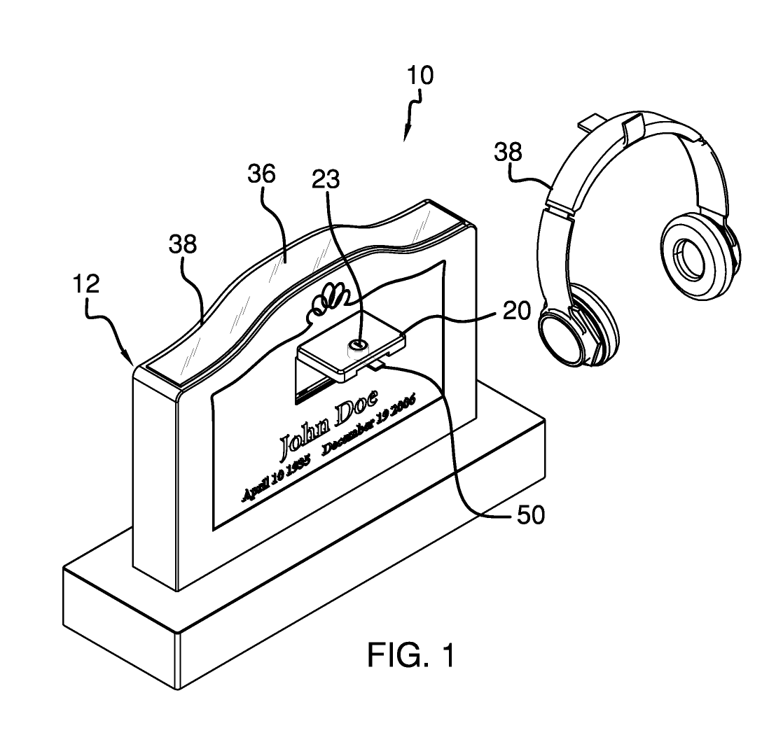

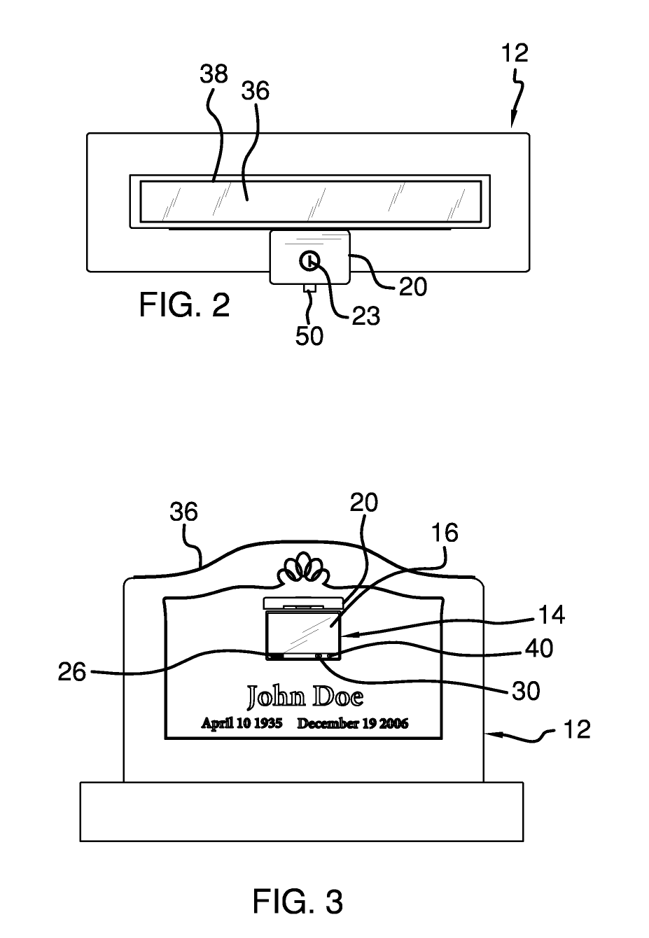

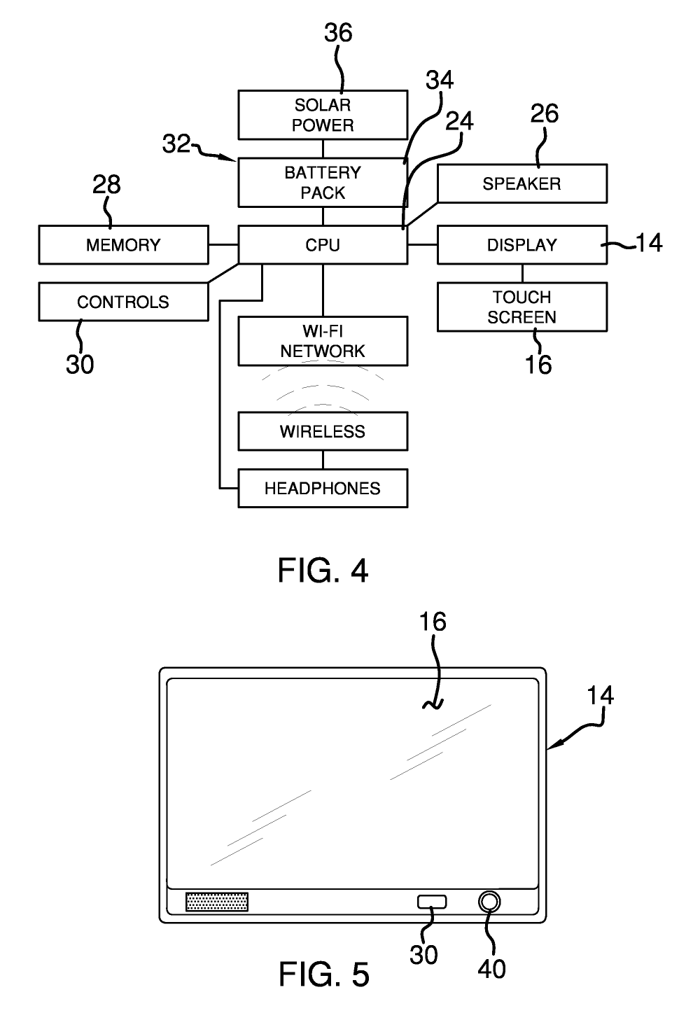

With reference now to the drawings, and in particular to FIGS. 1 through 5 thereof, a new memorial system embodying the principles and concepts of an embodiment of the disclosure and generally designated by the reference numeral 10 will be described.

As best illustrated in FIGS. 1 through 5, the electronic memorial system 10 generally comprises a grave marker 12 that is generally conventional and may be constructed from marble, concrete or the like. A display assembly 14 is coupled to the grave marker 12. The display assembly 14 includes a screen 16 for displaying visual information about a deceased person when the display assembly 14 is activated. The visual information may include pictures or video images related to the deceased person. The screen 16 may be a touch screen incorporating conventional touch screen technology.

A cover 20 is pivotally coupled to the grave marker 12. The cover 20 is positionable to cover the screen 16. The cover 20 may be constructed from a waterproof or water-resistant material, such as plastic or the like. A locking mechanism 22 is coupled to the cover 20. The locking mechanism 22 secures the cover 20 in a closed position covering the screen 16. The locking mechanism 22 may include a key slot 23 that is generally conventional and configured to receive a key wherein manipulation of the key within the key slot 23 selectively engages and disengages the locking mechanism 22 in a conventional manner.

A processor 24 is electrically coupled to the display assembly 14. A speaker 26 is electrically coupled to the processor 24 wherein the speaker 26 emits audio information about the deceased person when the speaker 26 is activated. The speaker 26 may be coupled to the display assembly 14. The audio information may include, for example, a message recorded by the deceased person, the deceased person's favorite song, or the like. An electronic memory 28 is electrically coupled to the processor 24. The electronic memory 28 stores the audio and visual information about the deceased person thereon. An actuator 30 is coupled to the display assembly and is electrically coupled to the processor 24. The actuator 30 controls the audio and visual information emitted from the system 10. A power source 32 is electrically coupled to the processor 24 for providing power to the processor 24. The power source 32 comprises at least one rechargeable battery 34. At least one solar cell 36 is electrically coupled to the battery 34 wherein the at least one solar cell 36 recharges the battery 34. Each solar cell 36 may be mounted on a top 38 of the grave marker 12.

A pair of headphones 38 is communicatively coupled to the processor 24 wherein the headphones 38 are configured to emit the audio information stored on the electronic memory 28. The headphones 38 may include either wired or wireless technology for transmitting the audio information through the headphones 38. Thus, the display assembly 14 may include an audio port 40 positioned therein. The audio port 40 is configured to receive a connecting end of the headphones 38 for electrically coupling the headphones 38 to the processor 24.

In use, the cover 20 is opened to expose the screen 16. The actuator 30 is manipulated to view the visual information and/or listen to the audio information stored on the electronic memory 28. The headphones 38 can be worn to listen to the audio information and may be done so either through a wired or wireless connection. Alternatively, the audio information may be transmitted through the speaker 26 on the display assembly 14 such that headphones 38 are not required.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. An electronic memorial system comprising:
a grave marker;
a display assembly coupled to said grave marker, said display assembly including a screen for displaying visual information about a deceased person when said display assembly is activated;
a processor electrically coupled to said display assembly; and
a speaker electrically coupled to said processor wherein said speaker emits audio information about the deceased person when said speaker is activated.

2. The system of claim 1, further comprising an electronic memory being electrically coupled to said processor, said electronic memory storing the audio and visual information about the deceased person thereon.

3. The system of claim 1, further comprising a cover pivotally coupled to said grave marker, said cover being positionable to close said opening and cover said screen.

4. The system of claim 1, further comprising an actuator coupled to said display assembly and being electrically coupled to said processor, said actuator controlling the audio and visual information being emitted from said system.

5. The system of claim 1, further comprising wherein said screen is a touch screen.

6. The system of claim 1, further comprising a power source being electrically coupled to said processor for providing power to said processor.

7. The system of claim 6, further comprising wherein said power source comprises at least one rechargeable battery.

8. The system of claim 7, further comprising at least one solar cell being electrically coupled to said battery wherein said at least one solar cell recharges said battery.

9. The system of claim 3, further comprising a locking mechanism coupled to said cover, said locking mechanism securing said cover in a closed position covering said screen.

10. The system of claim 1, further comprising a pair of headphones communicatively coupled to said processor wherein said headphones are configured to emit the audio information stored on said electronic memory.

11. The system of claim 10, further comprising wherein said display assembly includes an audio port positioned therein, said audio port being configured to receive a connecting end of said headphones for electrically coupling said headphones to said processor.

12. The system of claim 8, further comprising each said solar cell being mounted on a top of said grave marker.

13. An electronic memorial system comprising:
a grave marker;
a display assembly coupled to said grave marker, said display assembly including a screen for displaying visual information about a deceased person when said display assembly is activated, said screen being a touch screen;
a cover pivotally coupled to said grave marker, said cover being positionable to cover said screen;
a locking mechanism coupled to said cover, said locking mechanism securing said cover in a closed position covering said screen, said locking mechanism including a key slot configured to receive a key wherein manipulation of the key within said key slot selectively engages and disengages said locking mechanism;
a processor electrically coupled to said display assembly;
a speaker electrically coupled to said processor wherein said speaker emits audio information about the deceased person when said speaker is activated;
an electronic memory being electrically coupled to said processor, said electronic memory storing the audio and visual information about the deceased person thereon;
an actuator coupled to said display assembly and being electrically coupled to said processor, said actuator controlling the audio and visual information being emitted from said system;
a power source being electrically coupled to said processor for providing power to said processor, said power source comprising at least one rechargeable battery;
at least one solar cell being electrically coupled to said battery wherein said at least one solar cell recharges said battery, each said solar cell being mounted on a top of said grave marker; and
a pair of headphones communicatively coupled to said processor wherein said headphones are configured to emit the audio information stored on said electronic memory.

14. The system of claim 13, further comprising wherein said display assembly includes an audio port positioned therein, said audio port being configured to receive a connecting end of said headphones for electrically coupling said headphones to said processor.
